(19) United States
(12) Patent Application Publication
(10) Pub. No.: US 2007/0261645 A1
(43) Pub. Date: Nov. 15, 2007

(54) Pet leash apparatus and method using same

(76) Inventors: Ryan J. Van de Merwe, Tucson, AZ (US); Justin S. Cussick, Tucson, AZ (US)

Correspondence Address: DALE F. REGELMAN, LAW OFFICE OF DALE F. REGELMAN, P.C., 4231 SOUTH FREMONT AVENUE, TUCSON, AZ, 85714, US

(21) Appl. No.: 11/359,895

(22) Filed: Feb. 17, 2006

(51) Int. Cl. A01K 27/00

(52) U.S. Cl. 119/792

(57) ABSTRACT

A pet leash apparatus is disclosed. The pet leash apparatus comprising a hand-held control device comprising a housing, a fluid reservoir disposed within the housing and a fluid discharge port extending outwardly from the housing, a fluid conduit comprising a first end and a second end, where the first end of the fluid conduit is releaseably interconnected with the fluid discharge port, and a collar comprising a fluid input port interconnected with a fluid spray assembly, where the fluid input port is releaseably interconnected with the second end of the fluid conduit.

### FIELD OF THE INVENTION

The invention is directed to a pet leash apparatus and a method using same.

### BACKGROUND OF THE INVENTION

Pavlov demonstrated long ago the effectiveness of classical conditioning as an aid to learning. With the exception of the choker collar, the prior art teaches no apparatus or methods to dissuade a dog from pulling on leash. As those skilled in the art will appreciate, a choker collar has limited effectiveness, and is inhumane as the name would indicate. This prior art, inhumane, choker collar offers only limited effectiveness and can be hazardous to a dog's health. What is needed is an apparatus and method using that apparatus to effectively control a dog's behavior when the dog is attached to a leash.

In certain embodiments, Applicant's pet leash apparatus allows the user to cause the dog's collar to spray a liquid onto the dog's face/head to entice the dog to cease some undesirable behavior. In certain embodiments, the sprayed liquid comprises an odor which the dog can smell but which the user cannot. In certain embodiments, the liquid comprises an odor that is pleasant to humans but unpleasant to dogs. In either event, the sprayed liquid is not harmful to the dog.

In other embodiments, Applicant's pet leash apparatus allows the user to deliver an electrical shock to the dog, and/or spray the liquid from the collar, to entice the dog to cease the undesirable behavior. In still other embodiments, Applicant's pet leash apparatus allows the user to cause the dog's collar to emit ultrasonic sound waves, and/or deliver an electrical shock to the dog, and/or spray the liquid from the collar, to entice the dog to cease the undesirable behavior.

### SUMMARY OF THE INVENTION

Applicant's invention comprises a pet leash apparatus, comprising a hand-held control device comprising a housing, a fluid reservoir disposed within the housing and a fluid discharge port extending outwardly from the housing, a fluid conduit comprising a first end and a second end, where the first end is releaseably interconnected with the fluid discharge port, and a collar comprising a fluid input port interconnected with a fluid spray assembly, wherein the fluid input port is releaseably interconnected with the second end of the fluid conduit.

### BRIEF DESCRIPTION OF THE DRAWINGS

The invention will be better understood from a reading of the following detailed description taken in conjunction with the drawings in which like reference designators are used to designate like elements, and in which:

FIG. 1A is a perspective view of a first embodiment of the hand-held control device portion of Applicant's pet leash apparatus;

FIG. 1B is a cross-sectional view of the hand-held device of FIG. 1A;

FIG. 2 is a cross-sectional view of a second embodiment of the hand-held control device portion of Applicant's pet leash apparatus;

FIG. 3 is a cross-sectional view of a third embodiment of the hand-held control device portion of Applicant's pet leash apparatus;

FIG. 4 is a perspective view of a first embodiment of the fluid conduit portion of Applicant's pet leash apparatus;

FIG. 5 is a perspective view of a second embodiment of the fluid conduit portion of Applicant's pet leash apparatus;

FIG. 6 is a perspective view of a third embodiment of the fluid conduit portion of Applicant's pet leash apparatus;

FIG. 7 is a perspective view of a fourth embodiment of the fluid conduit portion of Applicant's pet leash apparatus;

FIG. 8 is a perspective view of a fifth embodiment of the fluid conduit portion of Applicant's pet leash apparatus;

FIG. 9 is a perspective view of a sixth embodiment of the fluid conduit portion of Applicant's pet leash apparatus;

FIG. 10 is a perspective view of a seventh embodiment of the fluid conduit portion of Applicant's pet leash apparatus;

FIG. 11 is a perspective view of an eighth embodiment of the fluid conduit portion of Applicant's pet leash apparatus;

FIG. 12 is a cross-sectional view of a first embodiment of the collar portion of Applicant's pet leash apparatus;

FIG. 13 is a cross-sectional view of a second embodiment of the collar portion of Applicant's pet leash apparatus;

FIG. 14 is a cross-sectional view of a third embodiment of the collar portion of Applicant's pet leash apparatus; and

FIG. 15 is a perspective view showing the elements of Applicant's pet leash apparatus.

### DETAILED DESCRIPTION OF THE PREFERRED EMBODIMENTS

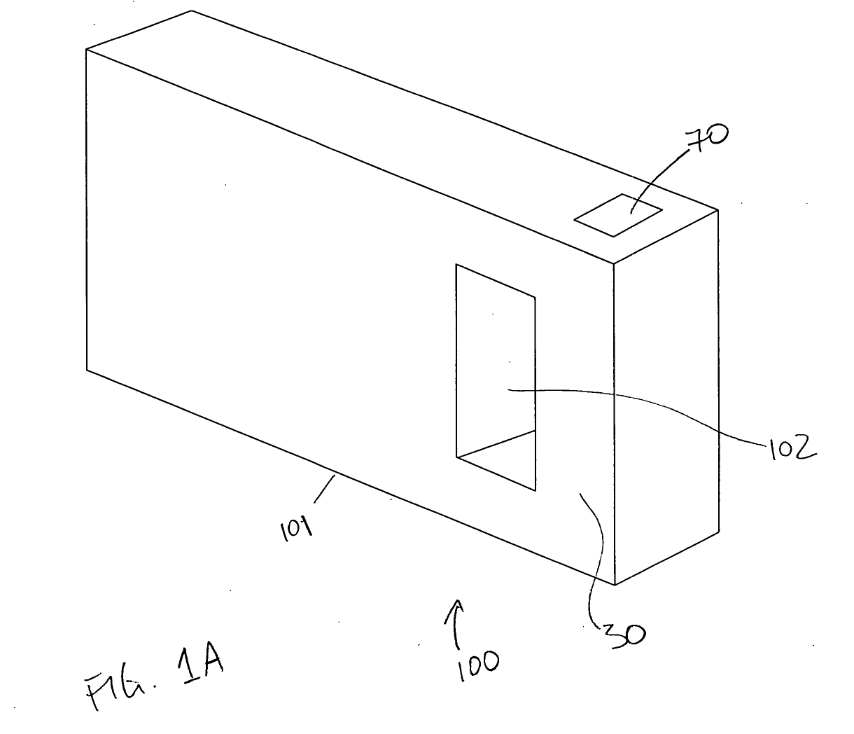

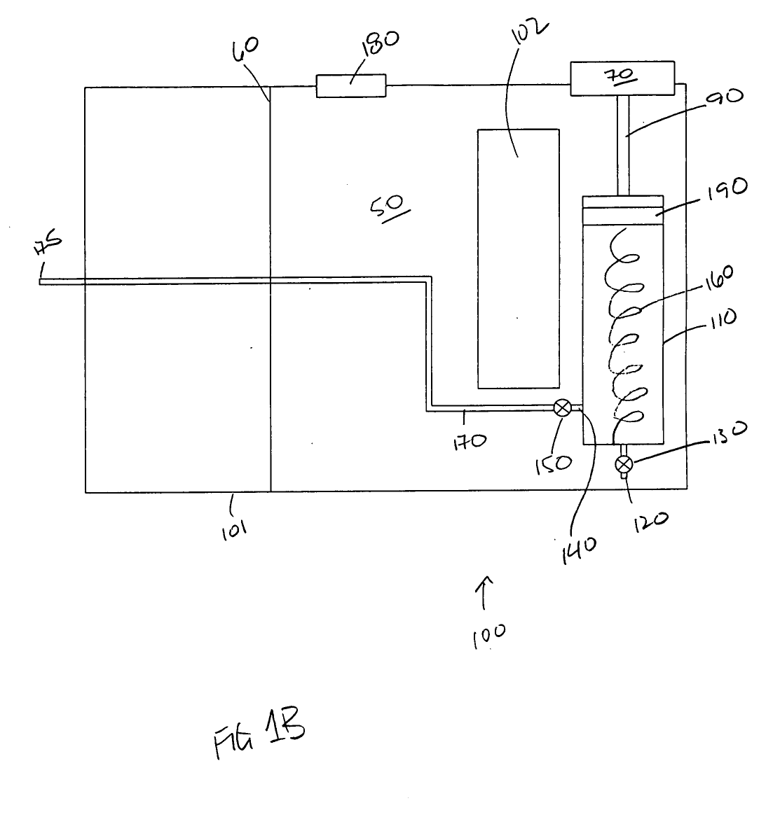

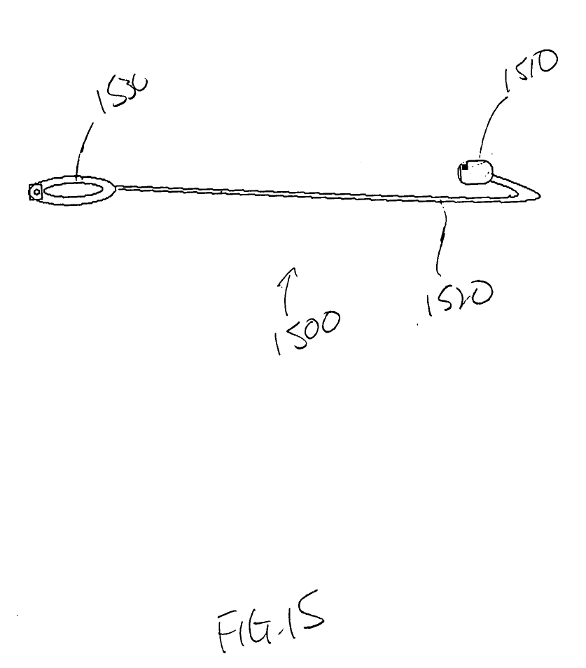

The invention is described in preferred embodiments in the following description with reference to the Figures, in which like numbers represent the same or similar elements. Referring now to FIG. 15, Applicant's pet leash apparatus 1500 comprises a hand-held control unit 1510, conduit 1520, and collar portion 1530, wherein conduit 1520 interconnects control unit 1510 and collar 1530. Referring now to FIG. 1A, in certain embodiments control unit 1510 comprises hand-held device 100. Hand-held device 100 comprises housing 101 which is formed to include a rectangular aperture 102 which defines handle portion 30.

Referring now to FIG. 1B, control unit 100 comprises a hand operated pump for manually pumping a liquid from the liquid reservoir 50 through the discharge port 175 of feed tube 170. In the illustrated embodiment of FIG. 1B, the pump is hand-operated by a button 70 moveably mounted to housing 101 and coupled by member 90 to a piston 190 movable within a cylinder 110. Cylinder 110 includes an inlet tube 120 leading to the bottom of the liquid reservoir 50 within handle 30 and having a one-way valve 130 permitting liquid to flow only into the cylinder. A removable refill cap 180 permits refilling the liquid reservoir 50 up to the partition 60.

Liquid is pumped out of the cylinder via an outlet tube 140 having a one-way valve 150 permitting the liquid to flow therethrough only out of the cylinder. A spring 160 within the cylinder urges piston 190 to its initial position illustrated in FIG. 1B.

Depressing button 70 downwardly moves the piston to the opposite end of the cylinder to pump the liquid out of cylinder 110, through feed tube 170, through the discharge end 175, into and through conduit 1520 (FIG. 15), and into and out of collar 1530 (FIG. 15).

In certain embodiments, Applicant's method using Applicant's apparatus 1500 includes disposing a liquid selected from the group consisting of water, citronella, anise oil, methyl nonyl ketone, thymol, cinnamic aldehyde, and mixtures thereof, into reservoir 50.

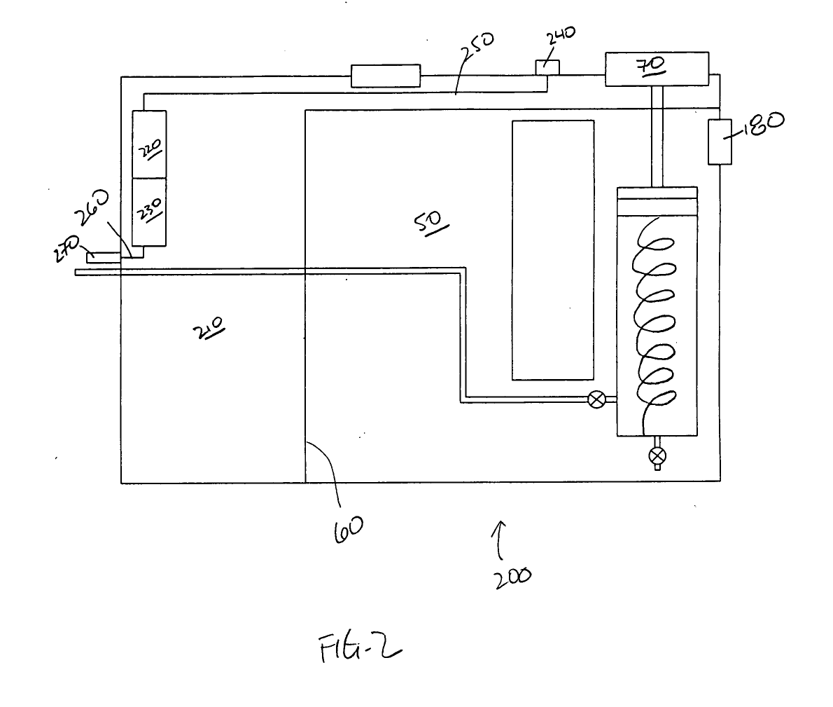

Referring now to FIG. 2, in certain embodiments control unit 1510 (FIG. 15) comprises assembly 200. Assembly 200 comprises the elements of assembly 100, and further comprises a power source, such as for example one or more batteries, such as batteries 220 and 230. In the illustrated embodiment of FIG. 2, assembly 200 comprises two removable batteries. In other embodiments, assembly 200 comprises one removable battery. In other embodiments, assembly 200 comprises more than two removable batteries.

The one or more batteries are interconnected with switch 240 via communication link/power conduit 250. Activating switch 240 causes the one or more batteries to provide power to power conduit 260 which is interconnected with power terminal 270.

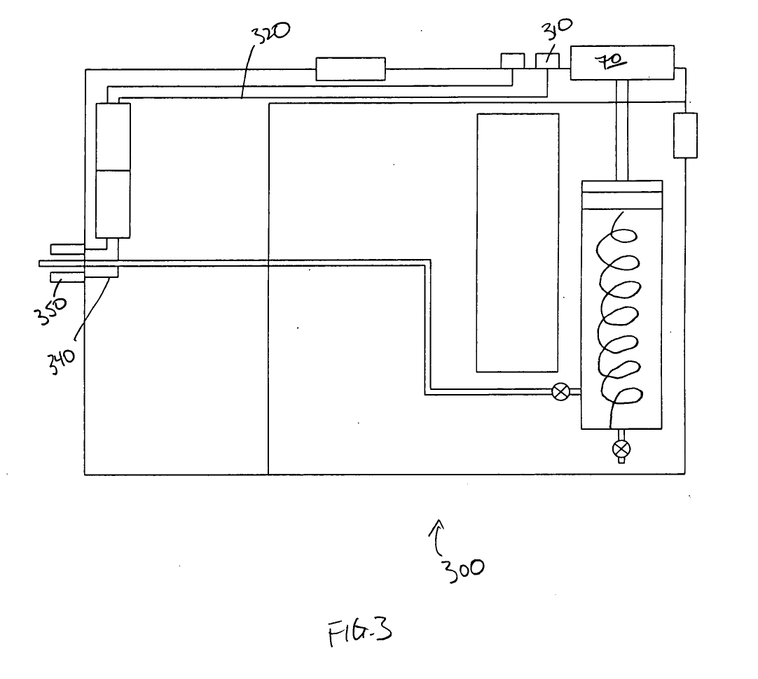

Referring now to FIG. 3, in certain embodiments control unit 1510 comprises assembly 300. Assembly 300 comprises the elements of assembly 200 in combination with switch 310. The one or more batteries are interconnected with switch 310 via communication link/power conduit 320. Activating switch 310 causes the one or more batteries to provide power to power conduit 340 which is interconnected with power terminal 350.

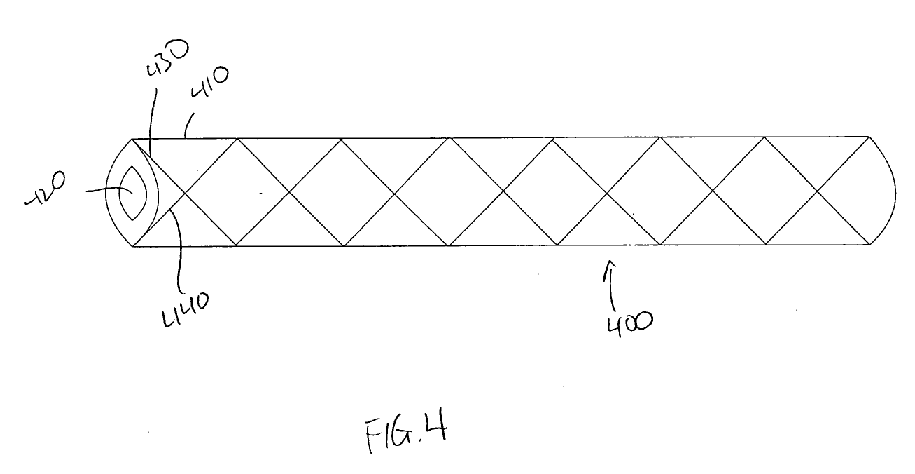

Referring now to FIG. 4, in certain embodiments fluid conduit 1520 comprises conduit 400. Conduit 400 comprises flexible tubular member 410 which encloses internal lumen 420. The diameter of tubular member 410 is adjusted such that tubular member 410 can be releaseably interconnected with assembly 100/200/300 such that discharge end 175 can be removeably inserted into lumen 420. In certain embodiments, tubular member 410 is formed from a material selected from the group comprising natural rubber, polyethylene, polypropylene, polyurethane, polyisoprene, polyisobutylene, polybutadiene, combinations thereof, and the like.

In the illustrated embodiment of FIG. 4, conduit 400 comprises an outer mesh interwoven from one or more strands 430 and one or more strands 440. In certain embodiments, one or more strands 430 and/or one or more strands 440 comprise one or more metal filaments, one or more polymeric filaments, one or more glass filaments, combinations thereof, and the like.

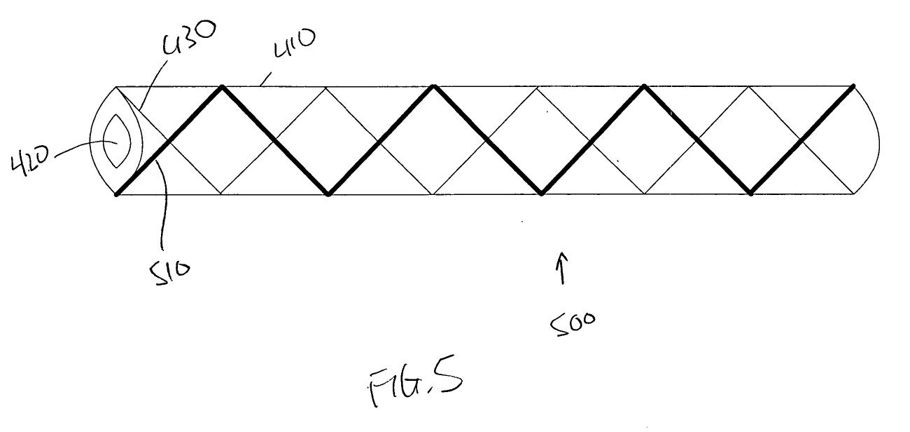

In certain embodiments, fluid conduit 1520 (FIG. 15) comprises conduit 500 (FIG. 5). Referring now to FIG. 5, in certain embodiments the one or more strands 440 comprise an electrical power conduit 510. In certain embodiments of Applicant's apparatus and method, conduit 500 is releaseably interconnected with hand-held control assembly 200 such that electrical power conduit 510 is releaseably interconnected with power terminal 270.

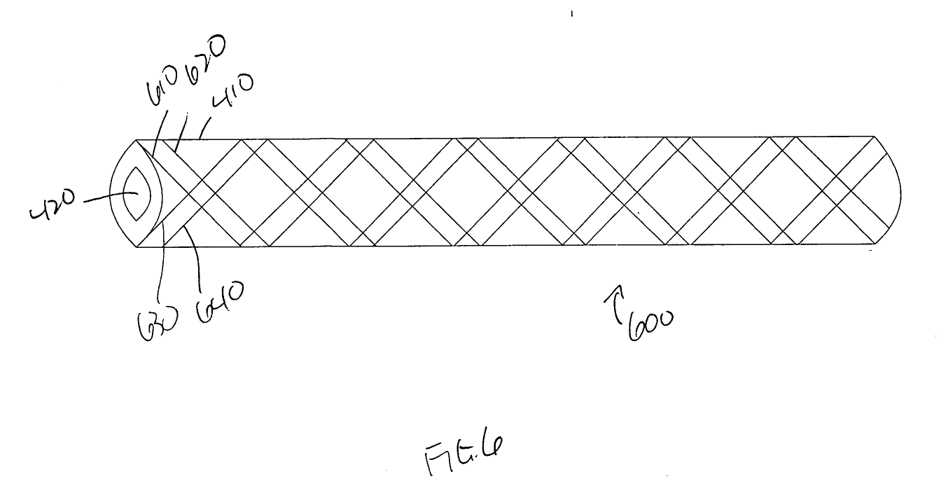

In certain embodiments, fluid conduit 1520 (FIG. 15) comprises conduit 600. Referring now to FIG. 6, conduit 600 comprises tubular member 410 enclosing lumen 420 in combination with an interwoven mesh comprising strands 610, 620, 630, and 640. In the illustrated embodiment of FIG. 6, the outer mesh structure formed from strands 610, 620, 630, and 6340, enclose about 50 percent of the exterior surface area of tubular member 410.

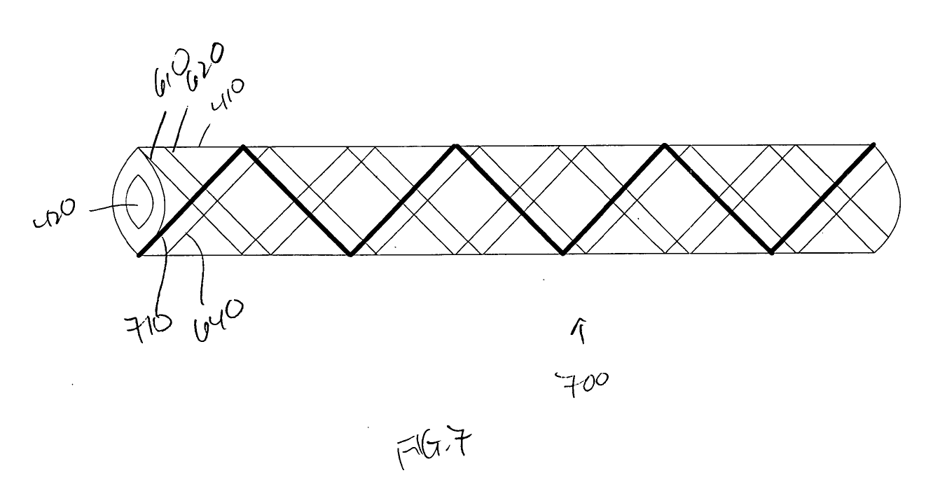

In certain embodiments, fluid conduit 1520 (FIG. 15) comprises conduit 700 (FIG. 7). Referring now to FIG. 7, in certain embodiments the one or more strands 630 comprise an electrical power conduit 710. In certain embodiments of Applicant's apparatus and method, conduit 700 is releaseably interconnected with hand-held control assembly 200 such that electrical power conduit 710 is releaseably interconnected with power terminal 270.

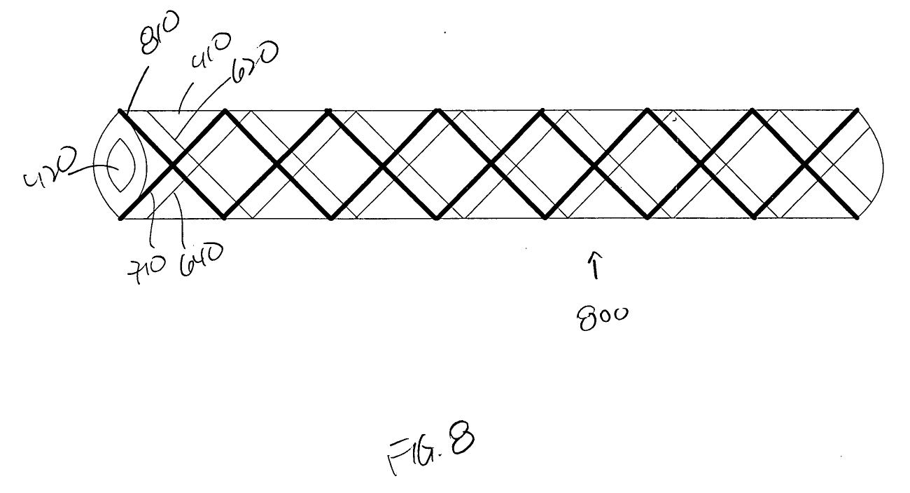

In certain embodiments, fluid conduit 1520 (FIG. 15) comprises conduit 800 (FIG. 8). Referring now to FIG. 8, in certain embodiments the one or more strands 630 comprise an electrical power conduit 710, and one or more of strands 610 comprises an electrical conduit 810. In certain embodiments of Applicant's apparatus and method, conduit 800 is releaseably interconnected with hand-held control assembly 300 such that electrical power conduit 710 is releaseably interconnected with power terminal 270, and such that power conduit 810 is releaseably interconnected with power terminal 350.

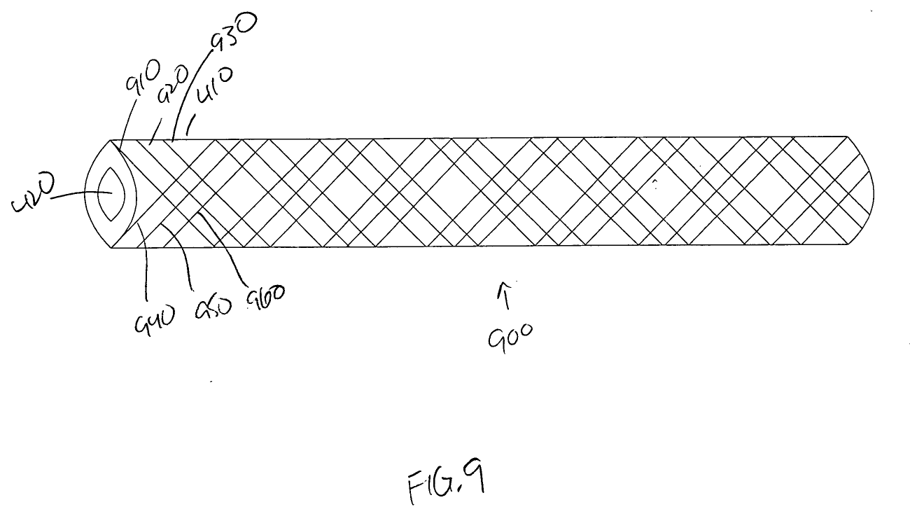

In certain embodiments, fluid conduit 1520 (FIG. 15) comprises conduit 900 (FIG. 9). Referring now to FIG. 9, conduit 900 comprises tubular member 410 enclosing lumen 420 in combination with an interwoven mesh comprising strands 910, 920, 930, 940, 950, and 960. In the illustrated embodiment of FIG. 9, the outer mesh structure formed from strands 910, 920, 930, 940, 950, and 960, enclose about 100 percent of the exterior surface area of tubular member 410.

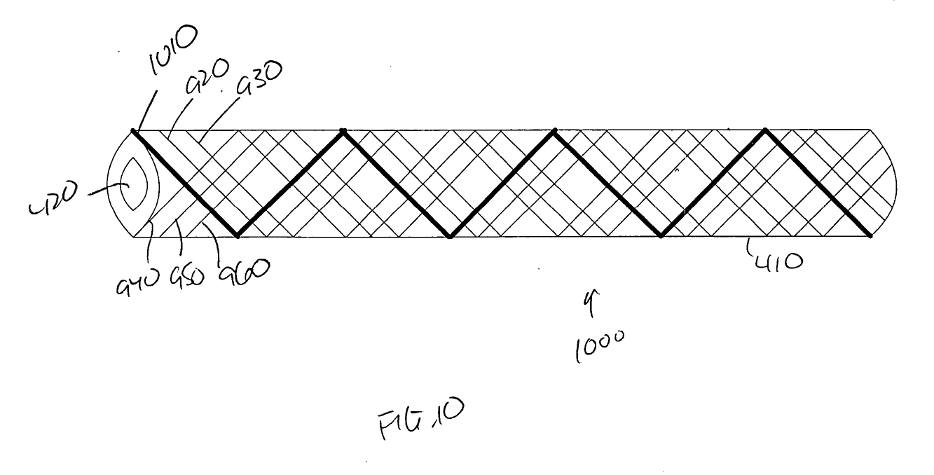

In certain embodiments, fluid conduit 1520 (FIG. 15) comprises conduit 1000 (FIG. 10). Referring now to FIG. 10, in certain embodiments the one or more strands 910 comprise an electrical power conduit 1010. In certain embodiments of Applicant's apparatus and method, conduit 1000 is releaseably interconnected with hand-held control assembly 200 such that electrical power conduit 1010 is releaseably interconnected with power terminal 270.

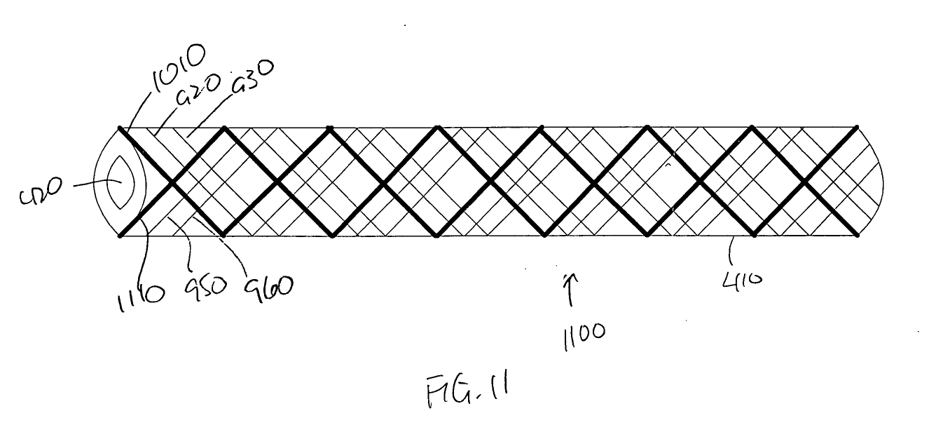

In certain embodiments, fluid conduit 1520 (FIG. 15) comprises conduit 1100 (FIG. 11). Referring now to FIG. 11, in certain embodiments the one or more strands 910 comprise an electrical power conduit 1010, and one or more of strands 940 comprises an electrical conduit 1110. In certain embodiments of Applicant's apparatus and method, conduit 1100 is releaseably interconnected with hand-held control assembly 300 such that electrical power conduit 1010 is releaseably interconnected with power terminal 270, and such that power conduit 1110 is releaseably interconnected with power terminal 350.

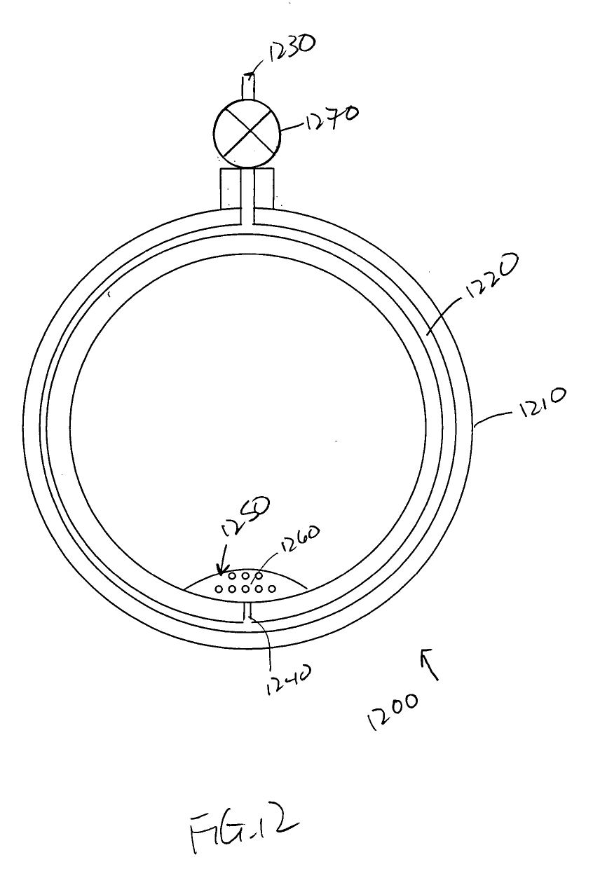

Referring now to FIG. 12, in certain embodiments Applicant's collar 1530 comprises assembly 1200. Assembly 1200 comprises tubular member 1210. In certain embodiments, tubular member 1210 is formed from leather. In certain embodiments, tubular member 1210 is formed from a polymeric material.

Fluid conduit 1220 is disposed with tubular member 1210, and is interconnected with fluid input port 1230 which extends through and outwardly from tubular member 1210. Fluid input port 1230 is dimensioned such that fluid conduit 400, 500, 600, 700, 800, 900, 1000, 1100, and/or 1520, can be releaseably interconnected with collar 1200 such that fluid input port 1230 can be removeably inserted into lumen 420.

Fluid conduit 1220 interconnects fluid input port 1230 and fluid output port 1240. In the illustrated embodiment of FIG. 12, collar 1200 comprises valve 1270 disposed between fluid input port 1230 and fluid conduit 1220. Valve 1270 can be adjusted to increase or decrease the quantity of fluid sprayed out of spray assembly 1250. In other embodiments, collar 1200 does not comprise valve 1270.

Fluid output port 1240 interconnects fluid conduit 1220 and fluid spray assembly 1250. In the illustrated embodiment of FIG. 12, fluid spray assembly 1250 comprises a plurality of apertures 1260. If fluid input port 1230 is releaseably interconnected with a first end of any one of fluid conduits 400, 500, 600, 700, 800, 900, 1000, 1100, and/or 1520, and if any one of hand-held control units 100, 200, 300, 1510, is releaseably interconnected with the second end of the selected fluid conduit via output port 175, then urging button 70 downwardly causes a portion of the fluid in chamber 50 to be sprayed from fluid spray assembly 1250.

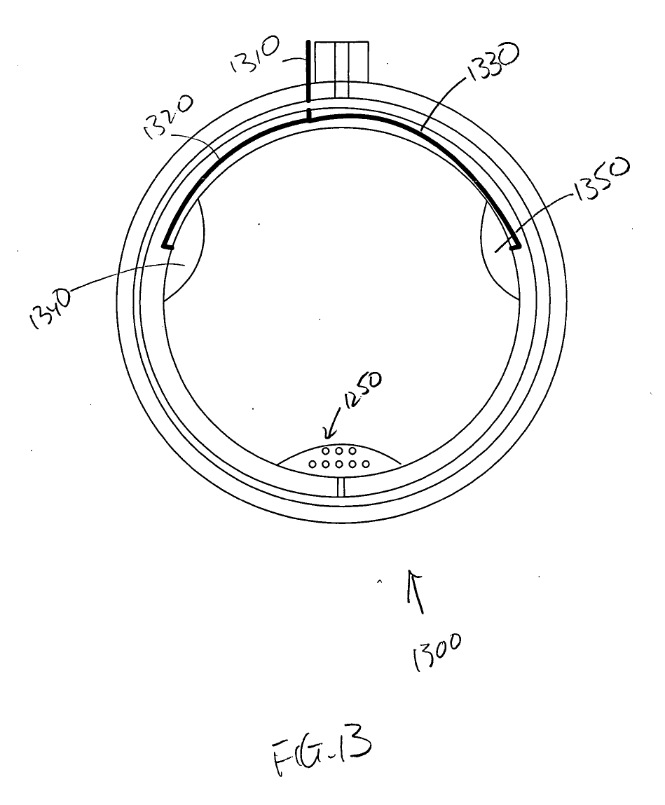

Referring now to FIG. 13, in certain embodiments Applicant's collar 1530 comprises assembly 1300. Collar 1300 comprises the elements of collar 1200 (FIG. 12) in combination with power input terminal 1310 which interconnects with power cable 1320 and power cable 1330. Power cable 1320 interconnects power input terminal 1310 and external electrode 1340 disposed on the external surface of tubular member 1210. Power cable 1330 interconnects power input terminal 1310 and external electrode 1350 disposed of the external surface on tubular member 1210.

If collar 1300 (FIG. 13) is releaseably interconnected as described above with a first end of any one of fluid conduits 500 (FIG. 5), 700 (FIG. 7), or 1000 (FIG. 10), and if either hand-held control unit 200 or 300 is releaseably attached to the opposite end of the selected fluid conduit such that electrical conduit 510, 710, or 1010, respectively, is releaseably interconnected with power terminal 270 (FIGS. 2, 3) and also with power input terminal 1310 (FIG. 13), then activating switch 240 (FIGS. 2, 3) causes an electrical shock to be delivered to the pet wearing collar 1300 via electrodes 1340 and 1350. In addition, urging button 70 (FIGS. 1, 2, 3) downwardly causes a portion of the fluid in chamber 50 (FIGS. 1, 2, 3) to be sprayed from fluid spray assembly 1250 (FIGS. 12, 13, 14).

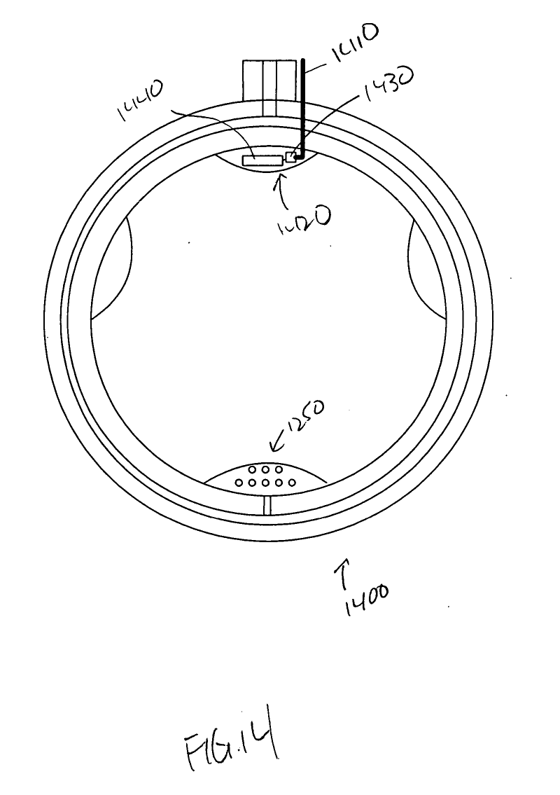

Referring now to FIG. 14, in certain embodiments Applicant's collar 1530 comprises assembly 1400. Collar 1400 comprises the elements of collar 1300 (FIG. 13) in combination with power input terminal 1410 which interconnects ultrasound emitting device 1420. In the illustrated embodiment of FIG. 14, ultrasound emitting device 1420 comprises piezoelectric transducer 1440 and power circuit 1430. In certain embodiments, power circuit 1430 chops the input DC power into an AC power signal. In certain embodiments, power circuit 1430 converts input DC power into an AC power output.

If collar 1400 (FIG. 14) is releaseably interconnected with hand-held control unit 300 (FIG. 3) using either fluid conduit 800 (FIG. 8) or 1100 (FIG. 1), such that electrical conduit 710 (FIGS. 7, 8) or 1010 (FIGS. 10, 11) respectively, is releaseably interconnected with power terminal 270 (FIGS. 2, 3) and with power input terminal 1310 (FIG. 13), and such that electrical conduit 810 (FIG. 8) or 1110 (FIG. 1), respectively, is interconnected with power terminal 350 (FIG. 3) and power input terminal 1410 (FIG. 14), then activating switch 310 (FIG. 3) causes device 1420 (FIG. 14) to emit ultrasound sound waves, in addition activating switch 240 (FIGS. 2, 3) causes an electrical shock to be delivered to the pet via electrodes 1340 (FIG. 13) and 1350 (FIG. 13), while urging button 70 (FIGS. 1, 2, 3) downwardly causes a portion of the fluid in chamber 50 (FIGS. 1, 2, 3) to be sprayed from fluid spray assembly 1250 (FIG. 12).

While the preferred embodiments of the present invention have been illustrated in detail, it should be apparent that modifications and adaptations to those embodiments may occur to one skilled in the art without departing from the scope of the present invention as set forth in the following claims.

I claim:

1. A pet leash apparatus, comprising:
a hand-held control device comprising a housing, a fluid reservoir disposed within said housing and a fluid discharge port extending outwardly from said housing;
a fluid conduit comprising a first end and a second end, wherein said first end is releaseably interconnected with said fluid discharge port;
a collar comprising a fluid input port interconnected with a fluid spray assembly, wherein said fluid input port is releaseably interconnected with said second end of said fluid conduit.

2. The pet leash apparatus of claim 1, further comprising:
a button moveably attached to said housing;
a pump comprising a cylinder, a moveable piston disposed within said cylinder and interconnected with said button, an inlet tube interconnecting said cylinder and said fluid reservoir, and an outlet tube interconnected with said cylinder and with said fluid discharge port.

3. The pet leash apparatus of claim 2, further comprising a liquid disposed within said fluid reservoir.

4. The pet leash apparatus of claim 3, wherein said liquid is selected from the group consisting of water, citronella, anise oil, methyl nonyl ketone, thymol, cinnamic aldehyde, and mixtures thereof.

5. The pet leash apparatus of claim 2, further comprising:
a power source disposed within said housing;
a first power terminal extending outwardly from said housing;
a first switch disposed on said housing and interconnected with said power source and with said first power terminal;
wherein said fluid conduit further comprises a first power conduit having a first end and a second end;
wherein said collar further comprises an electrode;
wherein said first end of said first power conduit is interconnected with said first power terminal, and wherein said second end of said first power conduit is interconnected with said electrode.

6. The pet leash apparatus of claim 5, wherein said power source comprises one or more batteries.

7. The pet leash apparatus of claim 2, further comprising:
a power source disposed within said housing;
a first power terminal extending outwardly from said housing;
a first switch disposed on said housing and interconnected with said power source and with said first power terminal;
wherein said fluid conduit further comprises a first power conduit having a first end and a second end;
wherein said collar further comprises a piezoelectric transducer;
wherein said first end of said first power conduit is interconnected with said first power terminal, and wherein said second end of said first power conduit is interconnected with said piezoelectric transducer.

8. The pet leash apparatus of claim 7, wherein said power source comprises one or more batteries.

9. The pet leash apparatus of claim 7, further comprising:
a second power terminal extending outwardly from said housing;
a second switch disposed on said housing and interconnected with said power source and with said second power terminal;
wherein said fluid conduit further comprises a second power conduit having a first end and a second end;
wherein said collar further comprises a piezoelectric transducer;
wherein said first end of said second power conduit is interconnected with said second power terminal, and wherein said second end of said second power conduit is interconnected with said piezoelectric transducer.

10. The pet leash apparatus of claim 9, wherein said power source comprises one or more batteries.

11. A method to control the behavior of a pet on a leash, comprising the steps of:
providing a pet comprising a head and neck;
supplying a pet leash apparatus comprising a hand-held control device comprising a housing, a fluid reservoir disposed within said housing and a fluid discharge port extending outwardly from said housing; a fluid conduit comprising a first end and a second end, wherein said first end is releaseably interconnected with said fluid discharge port; and a collar comprising a fluid input port interconnected with a fluid spray assembly, wherein said fluid input port is releaseably interconnected with said second end of said fluid conduit;
supplying a liquid;
disposing said liquid in said fluid reservoir;
spraying said liquid from said fluid spray assembly.

12. The method of claim 11, wherein said supplying a pet leash apparatus further comprises supplying a hand-held device further comprising a depressible button moveably attached to said housing; and a pump comprising a cylinder, a moveable piston disposed within said cylinder and interconnected with said depressible button, an inlet tube interconnecting said cylinder and said fluid reservoir, and an outlet tube interconnected with said cylinder and with said fluid discharge port;
wherein said spraying step further comprises moving said depressible button downwardly thereby pumping said liquid from said liquid reservoir into and through said fluid conduit, and into and from said fluid spray assembly.

13. The method of claim 12, wherein said supplying a pet leash apparatus further comprises:
supplying a hand-held control device further comprising a power source disposed within said housing; a first power terminal extending outwardly from said housing; a first switch disposed on said housing and interconnected with said power source and with said first power terminal;
supplying a fluid conduit further comprising a first power conduit having a first end and a second end;
supplying a collar further comprising an electrode;
said method further comprising the steps of:
interconnecting said first end of said first power conduit with said first power terminal;
interconnecting said second end of said first power conduit with said electrode;
activating said first switch;
delivering an electric shock to said pet via said electrode.

14. The method of claim 13, wherein said supplying a pet leash apparatus further comprises:
supplying a hand-held control device further comprising a second power terminal extending outwardly from said housing; a second switch disposed on said housing and interconnected with said power source and with said second power terminal;
supplying a fluid conduit further comprising a second power conduit having a first end and a second end;
supplying a collar further comprising a piezoelectric transducer;
said method further comprising the steps of:
interconnecting said first end of said second power conduit with said second power terminal;
interconnecting said second end of said second power conduit with said piezoelectric transducer;
activating said second switch;
emitting ultrasound energy waves from said piezoelectric transducer.
